(19) United States
(12) Patent Application Publication
(10) Pub. No.: US 2018/0343852 A1
(43) Pub. Date: Dec. 6, 2018

(54) CRYOGENIC STORAGE BAG

(71) Applicant: THERMOGENESIS CORP., Rancho Cordova, CA (US)

(72) Inventor: Philip H. Coelho, Sacramento, CA (US)

(21) Appl. No.: 15/571,838

(22) PCT Filed: May 9, 2016
(86) PCT No.: PCT/US16/31496

§ 371 Date: Nov. 5, 2017

Related U.S. Application Data
(60) Provisional application No. 62/160,146, filed on May 12, 2015.

(51) Int. Cl. A01N 1/02; A61J 1/10; A61J 1/14; B01L 3/00

(52) U.S. Cl. CPC A01N 1/0263; A61J 1/10; B01L 2300/1894; B01L 3/505; A61J 1/1468

(57) ABSTRACT

A cryogenic storage bag for preserving various biological specimens at low temperatures for sustained periods. The storage bag comprises a plurality of storage compartments and a plurality of frangible tabs. At least two of the plurality of frangible tabs connect each of the plurality of storage compartments to an adjacent storage compartment. Each of the plurality of frangible tabs includes at least one notch and a narrowest portion located equidistant from at least two adjacent storage compartments. The at least one notch connects to walls of the at least two adjacent storage compartments utilizing a joining portion of each of the plurality of frangible tabs. The plurality of frangible tabs enables separation of the plurality of storage compartments from one another at cryogenic temperatures while retaining an effective hermetic integrity to each of the plurality of storage compartments.

### RELATED APPLICATIONS

This application claims priority from the U.S. provisional application with Ser. No. 62/160,146, which was filed on May 12, 2015. The disclosure of that provisional application is incorporated herein as if set out in full.

### BACKGROUND OF THE DISCLOSURE

### Technical Field of the Disclosure

The present disclosure relates generally to cryogenic storage bags, and more particularly to a cryogenic storage bag having multiple storage compartments, the compartments being connected together utilizing a plurality of frangible tabs that provide connections between the compartments at cryogenic temperatures to enable strong, reliable bonds at room temperature but simultaneously allow easy and reliable separation of the storage compartments from one another with a simple intentional rotating motion at cryogenic temperatures.

### Description of the Related Art

Cryogenic storage systems have been used in the art to preserve various biological specimens including but not limited to cells, blood, and living tissue at low temperatures for sustained periods. When biological specimens, and in particular blood products are stored in these cryogenic storage systems it is common to store them in plastic storage bags/cryogenic freezing bags. These bags are generally fabricated from materials that maintain sufficient strength to withstand both (a) normal handling at room temperature and cryogenic temperatures; and (b) the expansion of water based cell solutions/blood products during freezing. Such bags are also typically constructed of materials that are not toxic to cells. Examples of such materials include fluorinated ethylene propylene (FEP), ethylene vinyl acetate (EVA) and high molecular weight polyethylene (HMWPE).

Different fabrication methods for cryogenic freezing/storage bags have been developed. One such method includes welding at their perimeter two plastic sheets positioned on top of one another. Other methods include vacuum forming plastic sheets in three-dimensional molds before the edges are welded together; and blow molding heated liquid plastics in three-dimensional molds into a seamless construction. In this example, tubing and ports that provide ingress and egress of the cell solution/blood products are welded into the perimeter of the bags as part of the fabrication process.

Several existing cryogenic freezing bags permit the partition of liquid between multiple compartments. The most common design of such a bag includes two compartments, one containing 80% of the liquid cell solution/suspension, and the other containing 20%. This design includes liquid flow channels directly between the 80% and 20% compartments at their closest point, which permit the bag to be filled from an inlet tube attached to only one of the two compartments with the liquid being distributed between the two compartments via the flow channels. Generally, after both compartments are filled, the flow channels are sealed with a Radio Frequency (RF) sealer so that the compartments are attached but, theoretically, are separated from each other without violating the hermetic integrity of either compartment. Separating the two compartments without violating the integrity of either compartment requires that a precise cut be made through the center of the RF seals of the flow channels along the axis of the two compartments. Once filled with fluid and fully hermetically sealed at the input tube and between the compartments, the bags are placed in a canister, which is then placed in a cryogenic storage system.

Conventional plastic storage bags/cryogenic freezing bags suffer from several disadvantages. The act of sealing the liquid flow channels between the multiple compartments of the cryogenic freezing bags is problematic. RF seals are designed for sealing thick-walled Polyvinyl chloride (PVC) plastic tubes and consequently deliver more RF energy than is required for sealing the flow channels. This excessive RF energy causes a thinning of the material comprising and surrounding the seal. This thinned material is more fragile than non-thinned material and increases the likelihood of breakage or leakage at that point, and particularly so at cryogenic temperatures.

The difficulty of sealing the liquid flow channels is compounded by the presence of cell cryoprotectant in the blood product to be stored. The near universally utilized cryoprotectant for mononuclear cells is Dimethyl Sulfoxide (DMSO). DMSO changes the conductivity and dielectric constant of the blood such that when an RF sealer head energizes to seal a liquid flow channel, an electric arc is created between the sealing head and the DMSO/blood solution, which can puncture one or more of the compartment walls containing blood. When this occurs, the blood product in the punctured bag compartment is typically discarded as it becomes contaminated by the non-sterile exterior bag surface.

Another disadvantage of conventional cryogenic storage bags is that even if flow channels are successfully sealed by RF welding, in the circumstance in which one of the two compartments is desired to be retrieved from cryogenic temperatures and the other compartment retained at cryogenic temperatures, separation of one compartment from another requires careful cutting of the sealed region of the flow channels. In order to avoid transient warming events, which damage cell viability, this careful cutting is optimally conducted at cryogenic temperatures that generate a fog of condensed vapor droplets when the storage freezer lid is opened. The visibility obscuring fog and the fact that the cutting must be accomplished by a technician wearing heavy insulated gloves both contribute to an increased rate of human error during the cutting process. Further, the method of cutting slightly off the center-line of the RF seal can cause a leak and subsequent contamination of the blood product.

Due to these aforementioned limitations, some blood processing centers choose unsealing the compartments, thus sacrificing the benefits of being able to access multiple hermetically sealed aliquots of a rare cell solution.

Yet another disadvantage of conventional multi-compartment cryogenic storage bags is the required separation between the multiple compartments where the RF sealing must occur. This space must be wide enough to accommodate the sealer head, without allowing the sealer head to touch the walls of the compartments on either side, which when occurring increases the possibility of arcing. This lost storage volume inside the storage bag is very precious because the cryogenic storage system requires expensive vacuum jacketed capital equipment, LN2 distribution plumbing, and a continuous supply of LN2. Thus, this method requires and wastes a great deal of storage space that would otherwise be available for blood storage, thereby increasing the overall bulk of each multi-compartment bag. The more compartments there are, the greater will be the loss of storage capacity for all cryogenic storage freezers.

There is thus a need for a cryogenic storage bag that would achieve the post filling hermetic integrity of each cryogenic compartment. Further, such a needed storage bag would not require RF sealing of fluid channels between the compartments, which would enable the storage bag to withstand cryogenic temperatures without rupturing. Such a needed device would include a means to provide a durable connection between compartments at room temperature and frangible connection between the multiple compartments at cryogenic temperatures that would permit easy and reliable separation of the compartments from one another. Moreover, such a needed device would reduce the inter-compartmental space to minimize the space required for a given volume of fluid in order to optimize the cost effective storage of blood products in limited cryogenic storage space. To date no such device accomplishes these objectives but the present embodiment described herein.

### SUMMARY OF THE DISCLOSURE

To minimize the limitations found in the prior art, and to minimize other limitations that will be apparent upon the reading of the specification, the preferred embodiment of the present invention provides a cryogenic storage bag comprising a plurality of storage compartments and a plurality of tabs that will be both durable at room temperatures but frangible at cryogenic temperatures. Each compartment includes a top portion and a bottom portion. At least two of the plurality of frangible tabs connect each of the plurality of storage compartments to an adjacent storage compartment. Each of the plurality of frangible tabs includes at least one substantially V-shaped notch and a narrowest portion located equidistant from at least two adjacent storage compartments. The at least one notch connects to walls of the at least two adjacent storage compartments utilizing a joining portion of each of the plurality of frangible tabs. The narrowest portion is approximately 0.008-inch thickness and 0.1-inch long. The joining portion of each of the plurality of frangible tabs averages approximately 0.05-inch thickness and 0.005-inch radius. The plurality of frangible tabs enables easy and reliable separation of the plurality of cryogenic storage compartments from one another at cryogenic temperatures while retaining effective hermetic integrity to each of the plurality of storage compartments. The top portion and the bottom portion of the at least two adjacent storage compartments are connected to at least one of the plurality of frangible tabs. The at least two adjacent storage compartments are separated when the at least two adjacent storage compartments are rotated on a main axis relative to one another which causes the plurality of frangible tabs to fracture along the at least one notch at each of plurality of frangible tabs.

It is a first objective of the present invention to provide a cryogenic storage bag that minimizes the separation between adjacent multiple storage compartments without requiring any fluid channel between the storage compartments.

A second objective of the present invention is to provide a cryogenic storage bag in which the filling of each compartment and subsequent hermetic integrity of each storage compartment is achieved without direct fluid channels existing between the storage compartments, and subsequent requirement of sealing those fluid channels.

A third objective of the present invention is to provide a cryogenic storage bag that does not require sealing of fluid channels between the multiple storage compartments thereby preventing the creation of thin sections of plastic that become vulnerable to rupture at cryogenic temperature.

A fourth objective of the present invention is to provide a cryogenic storage bag in which each of the multiple compartments is connected to at least one filling tube extending from a mixing chamber having a mixture of at least one cryoprotectant and a biological specimen.

A further objective of the present invention is to provide a cryogenic storage bag that includes a plurality of frangible tabs that provides a durable connection between storage compartments at all temperatures above a glass transition temperature of the storage compartment material, but become frangible connections between the multiple compartments at cryogenic temperatures that are below the glass transition temperature of the compartment material, thereby enabling easy and reliable separation of the storage compartments from one another without compromising the hermetic integrity of the multiple compartments or the need to expose the cellular contents of the storage compartments to temperatures that may be harmful to the cells.

A still further objective of the present invention is to provide a cryogenic storage bag comprising multiple compartments which minimizes the inter-compartment space in order to minimize the space required for a given volume of fluid, thus optimizing the cost effective storage of biological specimen in limited cryogenic storage space.

These and other advantages and features of the present invention are described with specificity so as to make the present invention understandable to one of ordinary skill in the art.

### BRIEF DESCRIPTION OF THE DRAWINGS

In order to enhance their clarity and improve understanding of these various elements and embodiments of the invention, elements in the figures have not necessarily been drawn to scale. Furthermore, elements that are known to be common and well understood to those in the industry are not depicted in order to provide a clear view of the various embodiments of the invention. Thus, the drawings are generalized in form in the interest of clarity and conciseness.

FIG. 1 is a cross sectional view of at least two of a plurality of frangible tabs connected between at least two of a plurality of storage compartments of a cryogenic storage bag according to the preferred embodiment of the present invention;

FIG. 2 is a top perspective view of the plurality of storage compartments and the plurality of frangible tabs of the cryogenic storage bag according to the preferred embodiment of the present invention;

FIG. 3 is a top perspective view of the at least two adjacent storage compartments connected to the at least two of the plurality of frangible tabs of the cryogenic storage bag according to the preferred embodiment of the present invention; and

FIG. 4 is a side perspective view of the plurality of storage compartments connected to at least one filling tube extending from a mixing chamber according to the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term ‘about” means +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application. Throughout this description and “left” and “right” side references may be inverted without departing from the invention.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

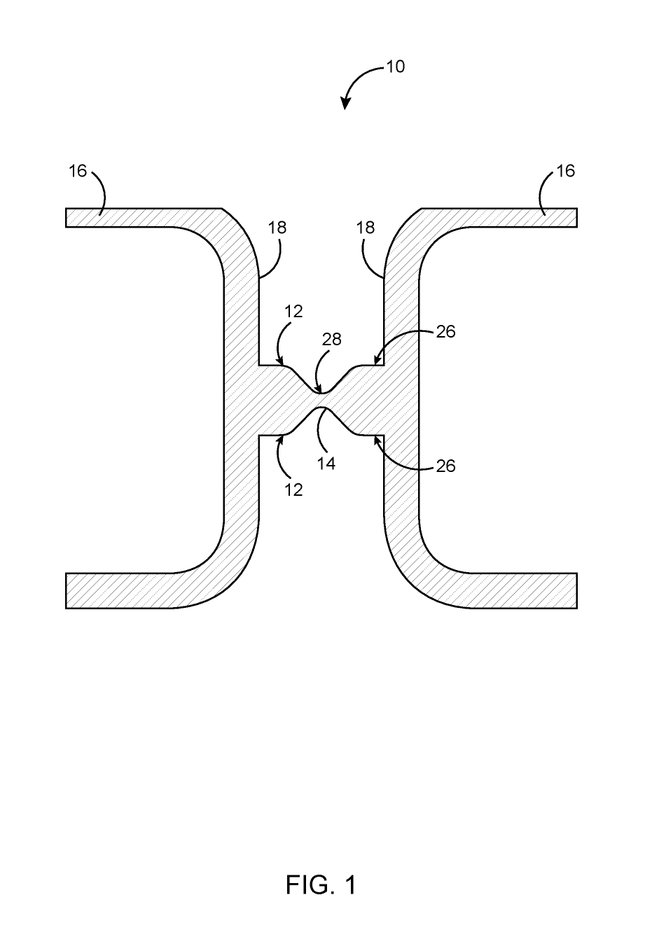

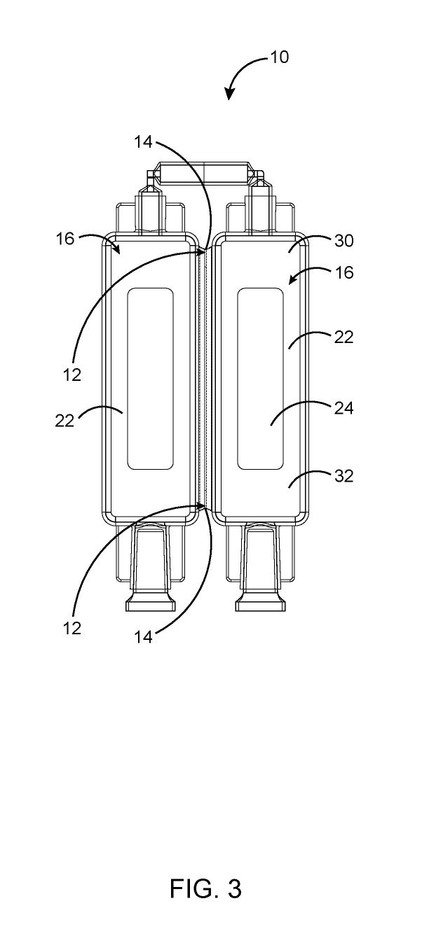

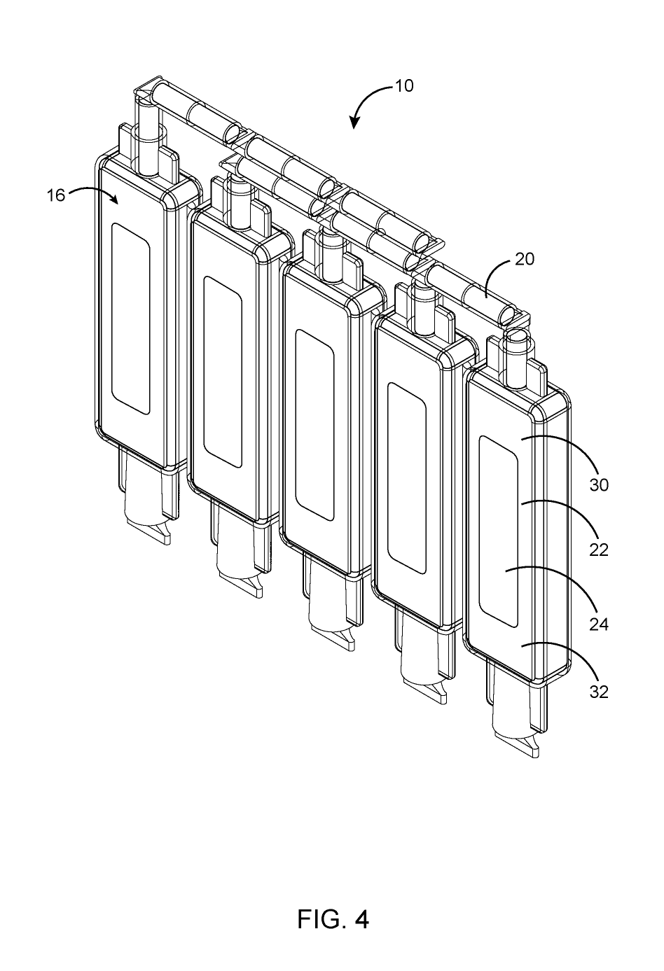

Referring first to FIGS. 1-4, a cryogenic storage bag for preserving various biological specimens such as cells, blood and living tissues at low temperatures for sustained periods according to the present invention is illustrated in different views and generally designated by the reference numeral 10.

Referring to FIG. 1, the cryogenic storage bag 10 comprises a plurality of storage compartments 16 and a plurality of frangible tabs 12. At least two of the plurality of frangible tabs 12 are connected between at least two adjacent storage compartments 16. Each of the plurality of frangible tabs 12 includes at least one substantially V-shaped notch 14. The at least one notch 14 connects to walls 18 of at least two adjacent storage compartments 16 utilizing a joining portion 26 of each of the plurality of frangible tabs 12. In the preferred embodiment, the joining portion 26 is approximately 0.05-inch thickness and approximately 0.005-inch radius. The frangible tab 12 includes a narrowest portion 28 located equidistant from the at least two adjacent storage compartments 16 and is approximately 0.008-inch thickness and approximately 0.1-inch long. The overall width of the frangible tabs 12, including the at least one notch 14, is approximately 0.090 inch wide. The plurality of frangible tabs 12 enables easy and reliable separation of the plurality of storage compartments 16 from one another at cryogenic temperatures while retaining effective hermetic integrity to each of the plurality of storage compartments 16. The plurality of frangible tabs 12 is durable at room temperature and frangible at cryogenic temperature.

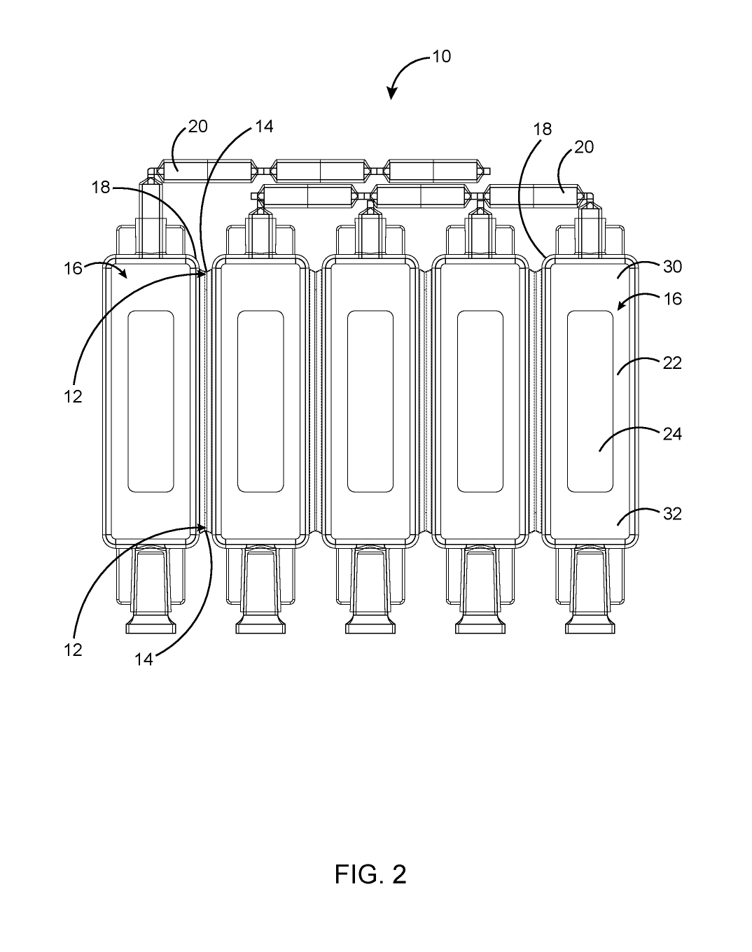

As shown in FIG. 2, a ratio of the width of the V-shaped notches 14 of the plurality of frangible tabs 12 to the overall width of the frangible tabs 12 contributes to isolating a point of fracture to the narrowest portion 28 (see FIG. 1) of the double V-shaped notches 14 thereby minimizing the chance of propagation into the walls 18 of the adjacent cryogenic storage compartment 16. In one configuration, the cryogenic storage bag 10 is blow molded ethylene vinyl acetate (EVA) type. In this configuration, a ratio of thickness of storage compartment wall 18 to the thickness of the narrowest portion 28 (see FIG. 1) of the double V-shaped notches 14 is in the range between about 1.0 and 5.0. A more preferred ratio is in the range of about 2.0 to 4.0, and a most preferred is a ratio of about 3.0. The plurality of frangible tabs 12 provide connections between the compartments at cryogenic temperatures to enable strong, reliable bonds at room temperature but allow easy and reliable separation of the storage compartments 16 from one another with a simple intentional rotating motion at cryogenic temperatures

As shown in FIGS. 2-4, the storage compartments 16 include a top portion 30 and a bottom portion 32. The top portion 30 and the bottom portion 32 of the at least two adjacent storage compartments 16 are connected to at least one of the plurality of frangible tabs 12. When a user wishes to separate the two adjacent compartments 16 of the storage bag 10, the two adjacent compartments 16 are rotated on a main axis relative to one another which causes the plurality of frangible tabs 12 to fracture along the at least one notch 14 at each of plurality of frangible tabs 12. Each of the plurality of storage compartments 16 is connected to at least one filling tube 20 extending from a mixing chamber (not shown) having a mixture of at least one cryoprotectant and a biological specimen. Each storage compartment 16 includes a label portion 24 located on an external surface 22 of the storage compartment 16 to label unit identification bar codes of the storage compartments 16.

As shown in FIG. 2, five storage compartments 16 are connected to one another utilizing the plurality of frangible tabs 12. Any number of storage compartments 16 can be stored in the preferred cryogenic storage bag 10. In one aspect of the preferred embodiment, the five storage compartments 16 are fabricated from EVA. Each wall 18 of the storage compartment 16 is 0.022-inch thickness and the frangible tab 12 is 0.09-inch-wide and 0.05-inch height with the substantially V-shaped notch 14 at a thinnest point of 0.008 inch. A ratio of the width of the V-shaped notch 14 to the overall width of the frangible tab 12 is 0.67. The frangible tabs 12 are attached at the top portion 30 and the bottom portion 32 of the two adjacent storage compartments 16. Since the joining portion 26 (FIG. 1) locates the structural weak point of the plurality of frangible tabs 12 equidistant from the at least two adjacent storage compartments 16, a rotation on the main axis of the storage compartments 16 provides clean and reliable separation of the adjacent storage compartments 16 from one another at the cryogenic temperatures while retaining the effective hermetic integrity to each of the storage compartments 16.

In the preferred configuration, the plurality of frangible tabs 12 is sufficiently strong such that they do not separate inadvertently, especially during normal handling of the cryogenic storage bag 10 at room temperature or at cryogenic temperatures. However, in certain situations, the frangible tabs 12 separate readily upon an application of precisely delivered mechanical force, yet even when this force is provided the frangible tabs 12 do not allow transmission of this mechanical force to the adjacent storage compartment walls 18. Preferably, the frangible tabs 12 are fabricated from same material of the storage compartments 16 thereby simplifying the construction of the cryogenic storage bag 10. In one embodiment, the frangible tabs 12 are fabricated utilizing a thin plastic material. However, other materials, configurations, and techniques are possible in other embodiments of the present invention. For example, in one alternative configuration of the cryogenic storage bag 10, the plurality of frangible tabs 12 extends along up to about 90% of the distance from the top portion 30 to the bottom portion 32 of the adjacent storage compartments 16 in a continuous fashion, or be interrupted to form sections or tabs. In another configuration, there are up to three interrupted frangible tabs 12, each one is approximately 10% of the length of an individual storage compartment 16 disposed evenly along the length of the frangible tab 12. In yet another configuration, there are two interrupted sections, each one is approximately 10% length of the edge of individual storage compartment 16, and is disposed near the top portion 30 and the bottom portion 32 of the storage compartments 16.

In the preferred embodiment, the cryogenic storage bag 10 is fabricated from blow molded EVA plastic. The cryogenic storage bag 10 can be fabricated from other materials such as, but not limited to, PVC and other plastics utilizing any common fabrication method such as RF or thermal welding. Preferably, typical wall thickness of the EVA cryogenic storage bag suitable for controlled-rate-freezing and cryogenic storage ranges between 0.015 and 0.03 inches, with a more preferred value of 0.02 to 0.028 inches, and most preferred is about 0.022 inches. The wall thickness is independent of any ratios described herein, and may be adjusted to suit the application.

In use, each storage compartment 16 of the cryogenic storage bag 10 is filled with approximately 5 ml of a mixture of blood as the biological specimen and Dimethyl Sulfoxide (DMSO) as cryoprotectant (4 ml of blood and 1 ml of 55% DMSO solution in Dextran 40). After RF sealing of the individual filling tubes 20 leading to each of the five individual compartments 16, the cryogenic storage bag 10 is placed in a metal canister for storage in liquid nitrogen (LN2). The temperature of the bag 10 and its contents can be lowered to −196 degrees Celsius by reducing the temperature utilizing any temperature reducing mechanism well known in the art. Thereafter, the canister is removed from the LN2 and the temperature of the canister, the cryogenic storage bag 10, and the inside contents is raised to a vapor phase of LN2. Upon raising the temperature, the canister is opened and the cryogenic storage bag 10 is carefully removed. While keeping the cryogenic storage bag 10 in the nitrogen vapor located just above the LN2, the rightmost compartment is rotated downwards, then upwards, with respect to the remaining four compartments 16. Thereafter, the rightmost compartment (See FIG. 2) is completely and cleanly separated from the adjacent storage compartment 16 along the V-notches of the at least two frangible tabs 12 without any propagation of fracture to the adjacent compartments 16. Subsequently, the remaining four compartments 16 are separated utilizing the aforementioned method.

In another configuration, after the step of temperature reduction, the cryogenic storage bag 10 is not fully removed from the canister while secured in the vapor phase nitrogen, but instead shifted to the right so that the frangible tabs 12 are positioned over the sharp edge of the canister. A downward motion is applied and the rightmost compartments 16 are separated along the V-notches 14 of the frangible tabs 12 with no propagation of fracture into the adjacent storage compartments 16.

In yet another configuration, a cleaning tool is utilized to cleanly separate the storage compartments 16. The cleaning tool includes a separating portion designed to descend into a region of the frangible tabs 12. The width of the separating portion is slightly less than the space between the storage compartments 16. A blade is positioned at the center of the cleaning tool and extended downwards from a bottom surface of the separating portion. This arrangement automatically positions the blade above the narrowest portion of the double V-notches 14 of the frangible tabs 12 as it was lowered to make contact with the frangible tabs 12. This method also results in a clean separation along the V-notches 14 of the frangible tabs 12.

The abovementioned methods provide different effective options for the reliable separation of the storage compartments 16 along the frangible tabs 12 when the cryogenic storage bag 10 is at cryogenic temperatures. However, these methods are in no way intended to be limiting. An added advantage of the preferred embodiment is that the number of compartments 16 may vary preferably between two and ten per cryogenic bag 10, but cryogenic bags 10 may be formed with ten or more individual compartments 16.

In the preferred embodiment, the filling of each storage compartment 16, and subsequent hermetic integrity of each storage compartment 16 is achieved without direct fluid channels existing between the storage compartments 16, and subsequent requirement to seal those fluid channels. A further advantage of the present invention is that the frangible tabs 12 provide a durable connection between storage compartments 16 at all temperatures above the glass transition temperature of the storage compartment material, including room temperature, but become frangible connections between the multiple compartments 16 at cryogenic temperatures that are below the glass transition temperature of the compartment material thereby enabling easy and reliable separation of the storage compartments 16 from one another without compromising the hermetic integrity of the multiple compartments 16 or the need to expose the cellular contents of the storage compartments 16 to temperatures that may be harmful to the biological specimen.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A cryogenic storage bag comprising:
a plurality of storage compartments, each compartment comprising a top portion and a bottom portion; and
a plurality of frangible tabs, at least two of the plurality of frangible tabs connecting each of the plurality of storage compartments to an adjacent storage compartment, wherein each of the plurality of frangible tabs includes at least one notch and a narrowest portion, the at least one notch connecting to walls of the at least two adjacent storage compartments utilizing a joining portion of each of the plurality of frangible tabs;
whereby the plurality of frangible tabs enables separation of the plurality of storage compartments from one another at cryogenic temperatures while retaining an effective hermetic integrity to each of the plurality of storage compartments.

2. The cryogenic storage bag of claim 1 wherein the joining portion of each of the plurality of frangible tabs is about 0.05 inch in thickness and has a radius of about 0.005 inch.

3. The cryogenic storage bag of claim 1 wherein the narrowest portion is located equidistant from the at least two adjacent storage compartments and approximately about 0.008-inch thickness and 0.1-inch long.

4. The cryogenic storage bag of claim 1 wherein the at least one notch is substantially V-shaped.

5. The cryogenic storage bag of claim 1 wherein the top portion and the bottom portion of the at least two adjacent storage compartments are connected to at least one of the plurality of frangible tabs.

6. The cryogenic storage bag of claim 1 wherein the at least two adjacent storage compartments are separated when the at least two adjacent storage compartments are rotated on a main axis relative to one another which causes the plurality of frangible tabs to fracture along the at least one notch at each of the plurality of frangible tabs.

7. The cryogenic storage bag of claim 1 wherein each of the plurality of storage compartments is connected to at least one filling tube extending from a mixing chamber having a mixture of at least one cryoprotectant and a biological specimen.

8. The cryogenic storage bag of claim 1 wherein each compartment has a glass transition temperature and the frangible tab provides a durable connection between storage compartments at temperatures above the glass transition temperature and provides a frangible connection between storage compartments at temperatures below the glass transition temperature.

9. A cryogenic storage bag comprising:
a plurality of storage compartments, each storage compartment including a top portion and a bottom portion; and
a plurality of frangible tabs, at least two of the plurality of frangible tabs connecting each of the plurality of storage compartments to an adjacent storage compartment, wherein each of the plurality of frangible tabs includes at least one substantially V-shaped notch and a narrowest portion located equidistant from at least two adjacent storage compartments, the at least one notch connects to walls of the at least two adjacent storage compartments utilizing a joining portion of each of the plurality of frangible tabs;
whereby the plurality of frangible tabs enables separation of the plurality of storage compartments from one another at cryogenic temperatures while retaining an effective hermetic integrity to each of the plurality of storage compartments.

10. The cryogenic storage bag of claim 9 wherein the joining portion of each of the plurality of frangible tabs is about 0.05-inch thickness and 0.005-inch radius.

11. The cryogenic storage bag of claim 9 wherein the narrowest portion is about 0.008-inch thickness and about 0.1 inch long.

12. The cryogenic storage bag of claim 9 wherein the top portion and the bottom portion of the at least two adjacent storage compartments are connected to at least one of the plurality of frangible tabs.

13. The cryogenic storage bag of claim 9 wherein the at least two adjacent storage compartments are separated when the at least two adjacent storage compartments are rotated on a main axis relative to one another which causes the plurality of frangible tabs to fracture along the at least one notch at each of the plurality of frangible tabs.

14. The cryogenic storage bag of claim 9 wherein each of the plurality of storage compartments is connected to at least one filling tube extending from a mixing chamber having a mixture of at least one cryoprotectant and a biological specimen.

15. The cryogenic storage bag of claim 9 wherein each compartment has a glass transition temperature and the frangible tab provides a durable connection between storage compartments at temperatures above the glass transition temperature and provides a frangible connection between storage compartments at temperatures below the glass temperature.

16. A cryogenic storage bag comprising:
a plurality of storage compartments, each compartment including a top portion and a bottom portion; and
a plurality of frangible tabs, at least two of the plurality of frangible tabs connecting each of the plurality of storage compartments to an adjacent storage compartment, wherein each of the plurality of frangible tabs includes at least one substantially V-shaped notch and a narrowest portion located equidistant from at least two adjacent storage compartments, wherein the at least one notch connects to walls of the at least two adjacent storage compartments utilizing a joining portion of each of the plurality of frangible tabs, wherein the narrowest portion is about 0.008 inch thickness and about 0.1 inch long and the joining portion of each of the plurality of frangible tabs averages about 0.05 inch thickness and 0.005 inch radius;
whereby the plurality of frangible tabs enables separation of the plurality of cryogenic storage compartments from one another at cryogenic temperatures while retaining effective hermetic integrity to each of the plurality of storage compartments.

17. The cryogenic storage bag of claim 16 wherein the top portion and the bottom portion of the at least two adjacent storage compartments are connected to at least one of the plurality of frangible tabs.

18. The cryogenic storage bag of claim 16 wherein the at least two adjacent storage compartments are separated when the at least two adjacent storage compartments are rotated on a main axis relative to one another which causes the plurality of frangible tabs to fracture along the at least one notch at each of plurality of frangible tabs.

19. The cryogenic storage bag of claim 16 wherein each compartment has a glass transition temperature and the frangible tab provides a durable connection between storage compartments at temperatures above the glass transition temperature and provides a frangible connection between storage compartments at temperatures below the glass temperature.
